(19) United States
(12) Patent Application Publication
(10) Pub. No.: US 2004/0192832 A1
(43) Pub. Date: Sep. 30, 2004

(54) Transparent biphase composition for topical application

(75) Inventor: Laurent Cordier, Roquebrune cap Martin (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 10/717,548

(22) Filed: Nov. 21, 2003

Related U.S. Application Data
(60) Provisional application No. 60/432,624, filed on Dec. 12, 2002.

(30) Foreign Application Priority Data
Nov. 26, 2002 (FR) 0214827

(51) Int. Cl. C08L 83/00

(52) U.S. Cl. 524/588

(57) ABSTRACT

The invention relates to a composition, which can be used for cosmetic purposes such as hair and skin care, the composition having a distinct aqueous phase and a distinct oily phase, the aqueous phase comprising at least 40% by weight with respect to the total weight of the aqueous phase of one or more polyols, and the oily phase comprising at least 5% by weight with respect to the total weight of the oily phase of one or more silicone oils, wherein the quantity of polyols and the quantity of silicone oils being such that the refractive indices of the two phases are substantially identical.

### FIELD OF THE INVENTION

The present invention relates to a composition for topical application, constituted by two distinct phases, an aqueous phase and an oily phase, which emulsify readily by agitation to produce a clear composition, i.e. a transparent composition, and to the use of the said composition for removing makeup from, cleansing and/or for caring for the skin, lips and/or eyes, and/or for hair care.

### DISCUSSION OF THE BACKGROUND

Compositions of that type constituted by two distinct phases, in particular an aqueous phase and an oily phase, are generally termed “biphase compositions”. They are distinguished from emulsions by the fact that when left to stand, the two phases are distinct instead of being emulsified one in the other. Thus, when left to stand the two phases are separated by a single interface, while in emulsions, one of the phases is dispersed in the other in the form of a multitude of droplets, resulting in multiple interfaces, the said interfaces generally being stabilized by emulsifying surfactants and/or emulsifying polymers. Using biphase compositions requires initial agitation to form an extemporaneous emulsion, which must be of sufficient quality and stability to allow homogeneous application of the two phases, but such that when left to stand, the two phases rapidly separate and regain their initial state; that phenomenon is usually known as “dephasing”.

Biphase compositions have already been described, for example in European patent documents EP-A-0 370 856 and EP-A-0 603 080, in particular for eye makeup removal.

The biphase compositions described until now form an opaque emulsion following agitation, namely a mixture of two phases that are mutually immiscible. However, such compositions are generally presented in transparent containers, and the opacity of the two emulsified phases is not aesthetically pleasing. Furthermore, transparent compositions are becoming more desirable as, like water, transparency is the symbol of purity and thus of cleanliness, and transparent compositions are thus particularly appreciated by users.

However, when the two phases are immiscible, it is difficult to obtain a transparent mixture of those phases.

Thus, there exists a need for a biphase composition constituted by two distinct immiscible phases which, after agitation, produces a transparent emulsion while retaining the desired properties of biphase compositions, i.e. rapid dephasing into two transparent phases.

### SUMMARY OF THE INVENTION

Surprisingly, the Applicant has discovered that it is possible to obtain a transparent biphase composition which, after agitation, produces a transparent emulsion and which dephases again rapidly into two transparent phases by using an aqueous phase comprising one or more polyols in a sufficient quantity and an oily phase comprising one or more silicone oils in sufficient quantity.

More particularly, the invention provides a composition for topical application, constituted by a distinct transparent aqueous phase and a distinct transparent oily phase, the aqueous phase comprising at least 40% by weight with respect to the total weight of the aqueous phase of one or more polyols, and the oily phase comprising at least 5% by weight with respect to the total weight of the oily phase of one or more silicone oils, the quantities of polyols and silicone oils being such that the refractive indices of the oily and aqueous phases are substantially equal.

### DETAILED DESCRIPTION OF THE INVENTION

It is known that polyols can be introduced into emulsions in quite large quantities. However, it is surprising that it is possible to introduce a large quantity of polyols into biphase compositions and that after agitation, those compositions remain stable at the time of use, even in the absence of surfactants. Furthermore, it is surprising that the interface remains clean and stable after being left to stand.

The composition of the invention is intended for topical application; it contains a physiologically acceptable medium, i.e. a medium that is compatible with the skin, the mucous membranes, the hair and the scalp.

The composition of the invention comprises at least one distinct aqueous phase and one distinct oily phase. These said two phases are distinct, i.e. they are visible one above the other when left to stand. They are transparent when left to stand, and when the composition is agitated prior to use, the mixture obtained, constituted by the emulsion of one phase in the other, is transparent. The two phases may or may not be coloured.

The refractive indices of the-aqueous phase and the oily phase are substantially equal; the word “substantially” means that the difference between the refractive indices of the two phases does not exceed 0.005 and thus that the refractive indices of the two phases are equal to within 0.005. The refractive indices of the said phases are generally of the order of 1.39 to 1.47, these indices being measured at ambient temperature (20° C. to 25° C.).

The word “transparent” means that the turbidity of the composition is 300 NTU or less. The transparency of a composition can be measured by its turbidity, and NTU units (Nephelometric Turbidity Units) are the units of measurement for the turbidity of a composition. Turbidity can be measured, for example, using a HACH Company model 2100P turbidimeter; the tubes used for the measurement are those with reference numbers AR397A, catalogue number 24347-06. The measurements are carried out at ambient temperature (20° C. to 25° C.). The turbidity of the composition of the invention is generally 2 to 300 NTU, and is preferably 5 to 200 NTU.

Aqueous Phase

The aqueous phase comprises at least 40% of polyols with respect to the total weight of the aqueous phase. Thus, the quantity of polyols is preferably at least 10% by weight with respect to the total composition weight, and can be from 10% to 90% by weight, for example, and is preferably 15% to 50% by weight with respect to the total composition weight.

The term “polyol” means any organic molecule comprising at least two free hydroxyl groups. Examples of polyols that can be cited are glycerine, glycols such as butylene glycol, propylene glycol, isoprene glycol, dipropylene glycol, hexylene glycol and polyethylene glycols, sorbitol, sugars such as glucose, and mixtures thereof. In a preferred implementation of the invention, the polyol is glycerine, dipropylene glycol or mixtures thereof, or a mixture of glycerine and/or dipropylene glycol and one or more other polyols in particular selected from those indicated above: butylene glycol, propylene glycol, isoprene glycol, hexylene glycol, polyethylene glycols, sorbitol, sugars and mixtures thereof.

In addition to polyols, the aqueous phase of the composition of the invention comprises water and any hydrosoluble or hydrodispersible additive. The water used can be sterile demineralized water and/or a floral water such as rose water, cornflower water, chamomile water or lime blossom water, and/or hot spa water or natural mineral water, such as Vittel water, Vichy basin water, Uriage spa water, La Roche-Posay spa water, Bourboule spa water, Enghien-les-Bains water, Saint Gervais-les-Bains water, Néris-les-Bains water, Allevar-les-Bains water, Digne spa water, Maizières spa water, Neyrac-les-Bains water, Lons-le-Saunier water, Eaux Bonnes spa water, Rochefort spa water, Saint Christau spa water, Fumades spa water, Tercis-les-Bains water and Avene spa water. The aqueous phase can also comprise reconstituted thermal spa water, i.e. water containing oligoelements such as zinc, copper, magnesium, etc., reconstituting the characteristics of thermal spa water.

The aqueous phase can also comprise a primary alcohol, i.e. an alcohol containing 1 to 6 carbon atoms, such as ethanol or isopropanol. It is preferably ethanol. The said alcohol can be present in a quantity of from 0.01% to 30% by weight, preferably 0.1% to 25% by weight with respect to the total composition weight. Adding such an alcohol may be particularly appropriate when the composition of the invention is used as a product for the body.

Preferably, the weight ratio between the aqueous phase and the oily phase is from 25/75 to 90/10, more preferably 30/70 to 70/30, still more preferably 40/60 to 60/40, and yet still more preferably 45/55 to 55/45. Thus, the aqueous phase generally represents 25% to 90% by weight, preferably 30% to 70% by weight, more preferably.40% to 60% by weight and still more preferably 45% to 55% by weight. with respect to the total composition weight.

Oily Phase

The oily phase generally represents 10% to 75%, preferably 30% to 70% by weight, more preferably 40% to 60% by weight and still more preferably 45% to 55% by weight with respect to the total composition weight.

The oily phase of the composition of the invention comprises at least 5% of one or more silicone oils with respect to the total weight of the oily phase. With respect to the total composition weight, the quantity of silicone oil(s) is preferably at least 0.5% by weight and this quantity can, for example, be from 0.5% to 70% by weight, preferably 5% to 65% by weight, more preferably 10% to 60% by weight and still more preferably 20% to 60% by weight with respect to the total composition weight.

The said silicone oils can be volatile or non-volatile. Furthermore, the oily phase can comprise one or more other oils, which may or may not be volatile, as indicated below, and liposoluble or lipodispersible additives.

The term “silicone oil” means an oil containing at least one silicon atom, and in particular containing Si—O groups. The silicone oil can be selected from non-volatile silicone oils, volatile silicone oils and mixtures thereof.

The volatile silicone oil that can be used in the invention can be selected from silicone oils with a flash point of 40° C. to 102° C., preferably with a flash point of more than 55° C. and no more than 95° C., and preferably 65° C. to 95° C. Examples of volatile silicone oils that can be cited are linear or cyclic silicone oils containing 2 to 7 silicon atoms, the said silicones optionally comprising alkyl or alkoxy groups containing 1 to 10 carbon atoms. Examples of volatile silicone oils that can be cited in particular are cyclopolydimethylsiloxanes (INCI name: cyclomethicone) such as cyclopentasiloxane, cyclohexasiloxane, octamethylcyclotetrasiloxane, decamethylcyclopentasiloxane, dodecamethylcyclohexasiloxane; linear silicones such as heptamethylhexyltrisiloxane, heptamethyloctyltrisiloxane, hexamethyldisiloxane, octamethyltrisiloxane, decamethyltetrasiloxane, dodecamethylpentasiloxane; and mixtures thereof.

The non-volatile silicone oil that can be used in the invention can be selected from polymethylsiloxanes (PDMS) and phenylated polymethylsiloxanes such as phenyltrimethicones, phenyldimethicones, phenyltrimethylsiloxydiphenylsiloxanes, diphenyldimethicones, diphenylmethyldiphenyltrisiloxanes, 2-phenylethyltrimethylsiloxysilicates and polymethylphenylsiloxanes; polysiloxanes modified with fatty acids, fatty alcohols or polyoxyalkylenes, and mixtures thereof.

Furthermore, the oily phase can contain one or more other volatile or non-volatile oils selected from hydrocarbonated oils, fluorinated oils and mixtures thereof.

The term “hydrocarbonated oil” means an oil essentially formed or constituted by carbon and hydrogen atoms and possibly containing oxygen or nitrogen atoms, and containing no silicon or fluorine atom; it may contain ester, ether, amine or amide groups.

The term “fluorinated oil” means an oil containing at least one fluorine atom.

Examples of oils that can be used in the composition of the invention that can be cited are:

hydrocarbonated oils of animal origin, such as perhydrosqualene;

hydrocarbonated oils of plant origin, such as liquid triglycerides of fatty acids containing 4 to 10 carbon atoms, such as triglycerides of heptanoic or octanoic acid or else, for example, sunflower seed, corn, soya bean, pumpkin, grapeseed, sesame, hazelnut, apricot kernel, macadamia nut, arara, coriander, castor or avocado oil, caprylic/capric acid triglycerides such as those sold by Stearineries Dubois or those sold under the trade name Miglyol 810, 812 and 818 by Dynamit Nobel, jojoba oil, karite butter oil;

synthesized esters and ethers, in particular of fatty acids, such as oils with formulae R¹COOR² and R¹OR² in which R¹ represents the residue of a fatty acid containing 8 to 29 carbon atoms, and R² represents a hydrocarbon-containing chain which may or may not be branched, containing 3 to 30 carbon atoms, such as Purcellin oil, isononyl isononanoate, isopropyl myristate, isopropyl palmitate, 2-ethylhexyl palmitate, 2-octyldodecyl stearate, 2-octyldodecyl erucate, isostearyl isostearate; hydroxylated esters such as isostearyl lactate, octylhydroxystearate, octyldodecyl hydroxystearate, diisostearyl malate, triisocetyl citrate, heptanoates, octanoates, fatty alcohol decanoates; polyol esters such as propylene glycol dioctanoate, neopentylglycol diheptanoate and diethylene glycol diisononanoate; and pentaerythritol esters such as pentaerythrityl tetraisostearate;

volatile or non-volatile, linear or branched hydrocarbons of mineral or synthetic origin and derivatives thereof, such as petroleum jelly oil or hydrogenated polyisobutene such as Parléam® oil; C₈-C₁₆ isoalkanes (also known as isoparaffins), isododecane, isodecane, isohexadecane, such as isoparaffins sold under the trade names Isopar by Exxon Chemical or oils sold under the trade name Permethyl by Presperse; and mixtures thereof;

fatty alcohols containing 8 to 26 carbon atoms, such as cetyl alcohol, stearyl alcohol and mixtures thereof (cetearyl alcohol), octyldodecanol, 2-butyloctanol, 2-hexyldecanol, 2-undecylpentadecanol or oleic alcohol.

In a preferred implementation of the invention, in addition to silicone oil(s), the composition contains at least one or more non-volatile oils selected, for example, from fatty acid esters containing 8 to 29 carbon atoms, such as isononyl isononanoate, isopropyl myristate, isopropyl palmitate, 2-ethylhexyl palmitate, 2-octyldodecyl stearate; linear hydrocarbons such as Parléam® oil and petroleum jelly oil; hydrocarbonated oils of plant origin such as apricot kernel oil; and mixtures thereof.

In the composition of the invention, with all oils considered together, the total quantity of non-volatile oil(s) can, for example be from 10% to 70% by weight, preferably 10% to 40% by weight with respect to the total composition weight, and the total quantity of volatile oils can, for example, be from 5% to 50% by weight, preferably 5% to 40% by weight and more preferably 5% to 30% by weight with respect to the total composition weight.

Surfactant

The biphase composition can optionally contain at least one surfactant in one or other of the phases. However, it can also be free of surfactant. When it contains a surfactant, the latter can be anionic, nonionic or amphoteric, but is preferably nonionic and/or anionic. It is preferably present in the aqueous phase.

The quantity of surfactant(s) in active ingredient must be such that the two phases remain distinct when left to stand and do not mix to form an emulsion. This quantity must generally be 1.5% or less by weight with respect to the total composition weight. As an example, it can be from 0.01% to 1.5% by weight, preferably 0.025% to 1% by weight and more preferably 0.05% to 0.5% by weight with respect to the total composition weight.

Particularly preferred nonionic surfactants are:

fatty esters of polyoxyethylenated sorbitol, such as the product sold under the trade name TWEEN 20 by ICI;

polyoxyethylenated fatty alcohols, such as the product sold under the trade name REMCOPAL 21912 AL by GERLAND;

polyoxyethylenated alkylphenols, such as the product sold under the trade name TRITON X 100 by RÖHM-HAAS; and

condensates of ethylene oxide and propylene oxide, such as those sold under the trade names SYNPERONIC PE by ICI and in particular those with reference numbers L 31, L 64, F 38, F 88, L 92, P 103, F 108 and F 127;

dimethicone copolyols or mixtures containing them, such as the product sold under the trade name DC 5225C by Dow Corning.

Examples of anionic surfactants that can be cited are:

alkylsulphates, alkyl ether sulphates and salts thereof, in particular their sodium salts, such as the mixture of Sodium Laureth Sulfate/Magnesium Laureth Sulfate/Sodium Laureth-8 Sulfate/Magnesium Laureth-8 Sulfate, sold under the trade name Texapon ASV by Henkel; sodium lauryl ether sulphate (C12-14 70/30) (2.2 OE) sold under the trade names SIPON AOS 225 or TEXAPON N702 PATE by Henkel, ammonium lauryl ether sulphate (C12-14 70/30) (3 OE) sold under the trade name SIPON LEA 370 by Henkel; ammonium alkyl (C12-C14) ether (9 OE) sulphate sold under the trade name RHODAPEX AB/20 by Rhodia Chimie;

alkylsulphoacetates such as those sold under the trade name LATHANOL LAL by STEPAN;

alkyl sulphosuccinates, for example oxyethylenated (3 OE) lauryl alcohol mono-sulphosuccinate (C12/C14 70/30) sold under the trade names SETACIN 103 SPECIAL, REWOPOL SB-FA 30 K 4 by Witco, the disodium salt of a hemi-sulphosuccinate of C12-C14 alcohols, sold under the trade name SETACIN F SPECIAL PASTE by Zschimmer Schwarz, oxyethylenated (2 OE) disodium oleamidosulphosuccinate sold under the trade name STANDAPOL SH 135 by Henkel, oxyethylenated (5 OE) lauric amide mono-sulphosuccinate sold under the trade name LEBON A-5000 by Sanyo, the oxyethylenated (10 OE) disodium salt of lauryl citrate sulphosuccinate sold under the trade name REWOPOL SB CS 50 by Witco, and disodium ricinoleamido mono-ethanolamide sulphosuccinate sold under the trade name REWODERM S 1333 by Witco;

polypeptides obtained, for example, by condensing a fatty chain with cereal amino acids and in particular that of wheat or oats, such as the potassium salt of hydrolyzed lauroyl wheat protein sold under the trade name AMINOFOAM W OR by Croda, the triethanolamine salt of hydrolyzed cocoyl soya bean protein sold under the trade name MAY-TEIN SY by Maybrook, the sodium salt of lauroyl oat amino acids sold under the trade name PROTEOL OAT by Seppic, a collagen hydrolysate grafted to copra fatty acid sold under the trade name GELIDERM 3000 by Deutsche Gelatine, soya proteins acylated by hydrogenated copra acids sold under the trade name PROTEOL VS 22 by Seppic;

amino acid derivatives, for example sarcosinates and in particular acylsarcosinates, such as sodium lauroyl sarcosinate sold under the trade name SARKOSYL NL 97 by Ciba or sold under the trade name ORAMIX L 30 by Seppic, sodium myristoyl sarcosinate sold under the trade name NIKKOL SARCOSINATE MN by Nikkol, sodium palmitoyl sarcosinate sold under the trade name NIKKOL SARCOSINATE PN by Nikkol; alaninates such as sodium N-lauroyl-N-methylamidopropionate sold under the trade name SODIUM NIKKOL ALANINATE LN 30 by Nikkol or sold under the trade name ALANONE ALE by Kawaken, and N-lauroyl-N-methylalanine triethanolamine sold under the trade name ALANONE ALTA by Kawaken; N-acylglutamates such as triethanolamine mono-cocoylglutamate sold under the trade name ACYLGLUTAMATE CT-12 by Ajinomoto, and triethanolamine lauroyl-glutamate sold under the trade name ACYLGLUTAMATE LT-12 by Ajinomoto; aspartates such as the mixture of triethanolamine N-lauroylaspartate and triethanolamine N-myristoylaspartate sold under the trade name ASPARACK LM-TS2 by Mitsubishi; glycine derivatives, such as sodium N-cocoylglycinate and potassium N-cocoylglycinate, such as the products sold under the trade name AMILITE GCS-12 and AMILITE GCK-i12 by Ajinomoto;

sulphonates, for example alpha-olefin sulphonates such as sodium alpha-olefin sulphonate (C14-C16) sold under the trade name BIO-TERGE AS-40 by Stepan, sold under the trade names WITCONATE AOS PROTEGE and SULFRAMINE AOS PH 12 by Witco or sold under the trade name BIO-TERGE AS-40 CG by Stepan, secondary sodium olefin sulphonate sold under the trade name HOSTAPUR SAS 30 by Clariant; linear alkyl aryl sulphonates such as sodium xylene sulphonate sold under the trade names MANROSOL SXS30, MANROSOL SXS40, MANROSOL SXS93 by Manro;

isethionates, in particular acylisethionates such as sodium cocoyl-isethionate, such as the product sold under the trade name JORDAPON CI P by Jordan.

Amphoteric or zwitterionic surfactants that can be cited include:

alkylamine alkylamido derivatives such as N-disodium N-cocoyl-N-carboxymethoxyethyl-N-carboxymethylethylenediamine (CTFA name: Disodium cocoamphodiacetate) sold in aqueous saline solution under the trade name MIRANOL C2M CONC NP by Rhodia Chimie; N-sodium N-cocoyl-N-hydroxyethyl-N-carboxymethyl-ethylenediamine (CTFA name: sodium cocampho-acetate) and the mixture of coco acid ethanolamides (CTFA name: Cocamide DEA);

betaines, for example cocobetaine, such as the product sold under the trade name DEHYTON AB-30 by Henkel, laurylbetaine such as the product sold under the trade name GENAGEN KB by Clariant, oxyethylenated (10 OE) laurylbetaine such as the product sold under the trade name LAURYLETHER (10 OE) BETAINE by Shin Nihon Rica, oxyethylenated (10 OE) stearylbetaine such as the product sold under the trade name STEARYLETHER (10 OE) BETAINE by Shin Nihon Rica;

alkylamidopropylbetaines and their derivatives, such as cocamidopropylbetaine sold under the trade name LEBON 2000 HG by Sanyo, or sold under the trade name EMPIGEN BB by Albright & Wilson, lauramidopropyl-betaine sold under the trade name REWOTERIC AMB12P by Witcotels, or cocamidopropylbetaine such as the products sold under the trade names TEGO BETAINE by GOLDSCHMIDT;

imidazoline derivatives, such as the product sold under the trade name CHIMEXANE HD by CHIMEX; and

mixtures thereof.

Adjuvants

The composition of the invention can also contain conventional cosmetic adjuvants or additives in one or the other phase depending on their hydrophilic or lipophilic nature, such as perfumes, preservatives and bactericides, colorants, softeners, buffers, humectants, UV filters (or sunscreens), electrolytes such as sodium chloride or a pH regulator such as citric acid or sodium hydroxide, and mixtures thereof.

Turning to preservatives, any preservative that is normally used in the fields under consideration, such as parabens or chlorhexidine gluconate, can be used.

Examples of bactericides that can be used are a glycerol mono(C₃-C₉)alkyl or (C₃-C₉)alkenylether, the production of which has been described in the literature, in particular by E. Baer, H.O.L. Fischer—J. Biol. Chem. 140-397-1941. Preferred glycerol mono(C₃-C₉)alkyl or (C₃-C₉)alkenylethers are 3-[(2-ethylhexyl)oxy]-1,2-propanediol, 3-[(heptyl)oxy]-1,2-propanediol, 3-[(octyl)oxy]-1,2-propanediol and 3-[(allyl)oxy]-1,2-propanediol. A more particularly preferred glycerol mono(C₃-C_{g})alkyl ether for the present invention is 3-[(2-ethylhexyl)oxy]-1,2-propanediol sold by SCHULKE & MAYR GmbH under the trade name SENSIVA SC 50 (INCI name: Ethylhexylglycerine).

Particular softening agents that can be used are allantoin and bisabollol, planktons, and certain plant extracts such as rose extracts and sweet clover extracts.

In accordance with the invention, the composition can also preferably further comprise, in the aqueous phase, a dephasing agent in a proportion of from 0.025% to 5% by weight with respect to the total composition weight.

Examples of dephasing agents that can be cited are alkyldimethylbenzylammonium chlorides such as those described in EP-A-0 603 080, in particular benzalkonium chloride, and mixtures containing it; alkoxylated alkyl glucosides containing a quaternary ammonium group and in particular lauryl methyl gluceth-10 hydroxypropyldimonium chloride as described in EP-A-0 847 746; vinylpyrrolidone polymers and copolymers, in particular polyvinylpyrrolidone/hexadecene copolymer as described in international patent application WO-A-99/56704; and mixtures thereof.

When such an agent is present, the ratio between the surfactant and the dephasing agent is preferably from 0.005/1 to 200/1, more preferably from 0.01/1 to 120/1.

Examples of active ingredients that can be used in the composition of the invention that can be cited are enzymes (for example lactoperoxidase, lipase, protease, phospholipase, cellulases); flavonoids; moisturizing agents such as protein hydrolysates; sodium hyaluronate; anti-inflammatories; procyannidolic oligomers; vitamins such as vitamin A (retinol), vitamin E (tocopherol), vitamin C (ascorbic acid), vitamin B5 (panthenol), vitamin B3 (niacinamide), derivatives of the said vitamins (in particular esters) and mixtures thereof; urea; caffeine; depigmenting agents such as kojic acid, hydroquinone and caffeic acid; salicylic acid and its derivatives; alpha-hydroxyacids such as lactic acid and glycolic acid and derivatives thereof; retinoids such as carotenoids and vitamin A derivatives; hydrocortisone; melatonin; extracts from algae, fungi, plants, yeasts, bacteria; steroids; antibacterial active ingredients such as 2,4,4′-trichloro-2′-hydroxy diphenyl ether (or triclosan), 3,4,4′-trichlorocarbanilide (or triclocarban) and the acids indicated above, especially salicylic acid and its derivatives; tightening agents; ceramides; essential oils; and mixtures thereof; and any active ingredient that is appropriate to the end use of the composition.

The UV filters that can be used in the composition of the invention are organic. They can be present in a quantity of active ingredient of from 0.01% to 20% by weight of active ingredient, preferably 0.1% to 15% by weight, and more preferably 0.2% to 10% by weight with respect to the total composition weight.

Examples of organic filters that are active in the UV-A and/or UV-B that can be added to the composition of the invention and which can be cited are derivatives with a sulphonic function such as sulphone or sulphonated derivatives of benzylidene camphor, benzophenone or phenylbenzimidazole, more particularly derivatives of benzylidene camphor such as benzene 1,4-[di(3-methylidene-campho-10-sulphonic)] acid (INCI name: Terephthalylidene Dicamphor Sulfonic Acid) produced under the trade name “MEXORYL SX” by CHIMEX, 4,′-sulpho-3-benzylidenecamphoric acid (INCI name: Benzylidene Camphor Sulfonic Acid) produced under the trade name “MEXORYL SL” by CHIMEX, 2-[4-(camphomethylidene)phenyl]benzimidazole-5-sulphonic acid, phenylbenzimidazole sulphonic acid (INCI name: Phenylbenzimidazole Sulfonic Acid), sold under the trade name EUSOLEX 232 by MERCK; para-aminobenzoic acid derivatives; salicylic derivatives such as ethylhexyl salicylate sold under the trade name NEO HELIOPAN OS by Haarmann & Reimer; dibenzoylmethane derivatives such as butyl methoxydibenzoylmethane sold under the trade name PARSOL 1789 by Hoffmann La Roche; cinnamic derivatives such as ethylhexyl methoxycinnamate sold under the trade name PARSOL MCX by Hoffmann La Roche; β, β′-diphenylacrylate derivatives such as octocrylene (2-ethylhexyl α-cyano-β,β-diphenylacrylate) sold under the trade name UVINUL N539 by BASF; benzophenone derivatives such as benzophenone-1 sold under the trade name UVINUL 400 by BASF, benzophenone-2 sold under the trade name UVINUL D50 by BASF, benzophenone-3 or oxybenzone sold under the trade name UVINUL M40 by BASF, benzophenone-4 sold under the trade name UVINUL MS40 by BASF; benzylidene camphor derivatives such as 4-methylbenzylidene camphor sold under the trade name EUSOLEX 6300 by MERCK; phenyl benzimidazole derivatives such as benzimidazilate sold under the trade name NEO HELIOPAN AP by Haarmann & Reimer; triazine derivatives such as anisotriazine sold under the trade name TINOSORB S by CIBA GEIGY and ethylhexyl triazone sold under the trade name UVINUL T 150 by BASF; phenyl benzotriazole derivatives such as drometrizole trisiloxane sold under the trade name SILATRIZOLE by Rhodia Chimie; anthranilic derivatives such as menthyl anthranilate sold under the trade name NEO HELIOPAN MA by Haarman & Reimer; imidazoline derivatives; benzalmalonate derivatives; and mixtures thereof.

The compositions described above can be packaged in a known manner in a single-compartment container. The user agitates the container before pouring the contents onto a cotton pad. It is also possible for the two phases of the composition to be introduced into two independent compartments of the same container, with a system being provided for mixing them for distribution. Such devices have been described, for example, in EP-A-0 497 256 and French patent FR-A-2 697 233.

The composition of the invention can be used for any topical application; in particular, it can constitute a cosmetic or dermatological composition. In particular, it can be used for caring for, cleansing and/or for removing makeup from the skin, lips and/or eyes, and also as a hair care composition.

The invention also concerns the cosmetic use of a cosmetic composition as defined above for caring for, removing makeup from and/or for cleansing the skin, lips and/or eyes, and/or for hair care.

The present invention also concerns a cosmetic method for removing makeup from, cleansing and caring for the skin, lips and/or eyes, characterized in that a cosmetic composition as defined above is applied to the skin, lips and/or eyes.

The present invention also concerns a cosmetic hair care method, characterized in that a cosmetic composition as defined above is applied to the hair.

The following examples of compositions of the invention are given by way of non-limiting illustration. Unless otherwise indicated, the quantities are given as a % by weight.

### EXAMPLES

### Example 1

### Makeup Removal Composition

Oily Phase

| | |
|---|---|
| Cyclopentasiloxane | 14% |
| Isododecane | 15% |
| Isopropyl palmitate | 19.5994% |
| Perfume | 0.2% |
| Colorant | 0.0006% |
| Ethylhexyloxyglycerine (Sensiva SC 50) | 1.2% |

Aqueous Phase

| | |
|---|---|
| Glycerine | 19.93% |
| Dipropylene glycol | 12.92% |
| Triethanolamine (neutralizing agent) | 0.07% |
| Methylparaben | 0.2% |
| Colorant | 0.00015% |
| Sodium chloride | 0.5% |
| Disodium EDTA (chelating agent) | 0.08% |
| Demineralized water | qsp 100% |

Protocol: The constituents of the oily phase and those of the aqueous phase were mixed. Then the two phases were mixed together.

A composition was obtained which, when left to stand, comprised a distinct coloured transparent aqueous phase and a distinct coloured transparent oily phase. On agitation, the two phases produced a transparent composition allowing good makeup removal from the skin, lips and eyes.

### Example 2

### Skin Care Composition

Oily Phase

| | |
|---|---|
| Cyclopentasiloxane | 23% |
| Hydrogenated polyisobutene | 14.5% |
| Apricot kernel oil (Prunus Armeniaca | 12.5% |
| Kernel Oil) | |

Aqueous Phase

| | |
|---|---|
| Dipropylene glycol | 45.5% |
| Chlorohexidine digluconate | 0.1% |
| Colorant (Blue 1) | 0.00015% |
| Demineralized water | 4.39985% |

Protocol: The constituents of the oily phase and those of the aqueous phase were mixed. Then the two phases were mixed together.

A composition was obtained which comprised a distinct transparent aqueous phase and a distinct transparent oily phase. On agitation, the two phases produced a transparent composition. This composition could be used in particular for skin care.

### Example 3

### Body Care Composition

Oily Phase

| | |
|---|---|
| Cyclopentasiloxane | 44.1% |
| Isononyl isononanoate | 3.5% |
| Vegetable oil | 1% |
| Perfume | 0.4% |
| Tocopherol acetate | 0.5% |
| Ethylhexyloxyglycerine (Sensiva SC 50) | 0.5% |

Aqueous Phase

| | |
|---|---|
| Glycerine | 20% |
| Propylene glycol | 1% |
| Panthenol | 0.3% |
| Colorant | 0.0001% |
| Ethanol | 18% |
| Perfume | 0.15% |
| Demineralized water | qsp 100% |

Protocol: The constituents of the oily phase and those of the aqueous phase were mixed. Then the two phases were mixed together.

A composition was obtained which comprised a distinct transparent aqueous phase and a distinct transparent oily phase. On agitation, the two phases produced a transparent composition. This composition could be used in particular for skin care.

1. A composition comprising a distinct transparent aqueous phase and a distinct transparent oily phase, wherein the aqueous phase comprises at least 40% by weight with respect to the weight of the aqueous phase of one or more polyols, and the oily phase comprises at least 5% by weight with respect to the weight of the oily phase of one or more silicone oils, wherein the one or more polyols and the one or more silicone oils are present in amounts such that the refractive indices of the oily and aqueous phases are substantially equal.

2. The composition according to claim 1, wherein the one or more polyols is present in an amount from 10% to 90% by weight with respect to the total composition weight.

3. The composition according to claim 1, wherein the one or more polyols is present in an amount from 15% to 50% by weight with respect to the total composition weight.

4. The composition according to claim 1, wherein the one or more polyols is selected from the group consisting of glycerine, glycols, sorbitol, sugars and mixtures thereof.

5. The composition of claim 4, wherein the one or more polyols is one or more glycols.

6. The composition according to claim 5, wherein the one or more glycols are selected from the group consisting of butylene glycol, propylene glycol, isoprene glycol, dipropylene glycol, hexylene glycol and polyethylene glycols.

7. The composition according to claim 1, wherein the weight ratio between the aqueous phase and the oily phase is from 40/60 to 60/40.

8. The composition according to claim 1, wherein the weight ratio between the aqueous phase and the oily phase is from 45/55 to 55/45.

9. The composition according to claim 1, wherein the oily phase comprises from 0.5% to 70% by weight with respect to the total composition weight of the one or more silicone oils.

10. The composition according to claim 1, wherein the oily phase comprises from 5% to 65% by weight with respect to the total composition weight of the one or more silicone oils.

11. The composition according to claim 1, wherein the one or more silicone oils is selected from the group consisting of non-volatile silicone oils, volatile silicone oils, and mixtures thereof.

12. The composition according to claim 1, wherein the oily phase further comprises at least one non-volatile oil selected from the group consisting of fatty acid esters containing 8 to 29 carbon atoms, hydrocarbonated oils of plant origin, linear hydrocarbons, and mixtures thereof.

13. The composition according to claim 1, which further comprises at least one surfactant selected from the group consisting of anionic surfactants, nonionic surfactants, and amphoteric surfactants.

14. The composition according to claim 13, wherein the at least one surfactant is present in a quantity of from 0.01% to 1.5% by weight with respect to the total composition weight.

15. The composition according to claim 1, which further comprises at least one dephasing agent.

16. The composition of claim 15, wherein the at least one dephasing agent is present in an amount from 0.025% to 5% by weight with respect to the total composition weight.

17. The composition according to claim 1, which is suitable for use as a cosmetic or dermatological composition.

18. A method of caring for, removing makeup from and/or for cleansing the skin, lips and/or eyes and/or hair, comprising applying the composition according to claim 1 to said skin, lips, eyes and/or hair.

19. A method of caring for, removing makeup from and/or for cleansing the skin, lips and/or eyes and/or hair, comprising applying the composition according to claim 2 to said skin, lips, eyes and/or hair.

20. A method of caring for, removing makeup from and/or for cleansing the skin, lips and/or eyes and/or hair, comprising applying the composition according to claim 3 to said skin, lips, eyes and/or hair.

21. A method of caring for, removing makeup from and/or for cleansing the skin, lips and/or eyes and/or hair, comprising applying the composition according to claim 4 to said skin, lips, eyes and/or hair.

22. A method of caring for, removing makeup from and/or for cleansing the skin, lips and/or eyes and/or hair, comprising applying the composition according to claim 5 to said skin, lips, eyes and/or hair.

23. A method of caring for, removing makeup from and/or for cleansing the skin, lips and/or eyes and/or hair, comprising applying the composition according to claim 6 to said skin, lips, eyes and/or hair.

24. A method of caring for, removing makeup from and/or for cleansing the skin, lips and/or eyes and/or hair, comprising applying the composition according to claim 7 to said skin, lips, eyes and/or hair.

25. A method of caring for, removing makeup from and/or for cleansing the skin, lips and/or eyes and/or hair, comprising applying the composition according to claim 8 to said skin, lips, eyes and/or hair.

26. A method of caring for, removing makeup from and/or for cleansing the skin, lips and/or eyes and/or hair, comprising applying the composition according to claim 9 to said skin, lips, eyes and/or hair.

27. A method of caring for, removing makeup from and/or for cleansing the skin, lips and/or eyes and/or hair, comprising applying the composition according to claim 10 to said skin, lips, eyes and/or hair.

28. A method of caring for, removing makeup from and/or for cleansing the skin, lips and/or eyes and/or hair, comprising applying the composition according to claim 11 to said skin, lips, eyes and/or hair.

29. A method of caring for, removing makeup from and/or for cleansing the skin, lips and/or eyes and/or hair, comprising applying the composition according to claim 12 to said skin, lips, eyes and/or hair.

30. A method of caring for, removing makeup from and/or for cleansing the skin, lips and/or eyes and/or hair, comprising applying the composition according to claim 13 to said skin, lips, eyes and/or hair.

31. A method of caring for, removing makeup from and/or for cleansing the skin, lips and/or eyes and/or hair, comprising applying the composition according to claim 14 to said skin, lips, eyes and/or hair.

32. A method of caring for, removing makeup from and/or for cleansing the skin, lips and/or eyes and/or hair, comprising applying the composition according to claim 15 to said skin, lips, eyes and/or hair.

33. A method of caring for, removing makeup from and/or for cleansing the skin, lips and/or eyes and/or hair, comprising applying the composition according to claim 16 to said skin, lips, eyes and/or hair.

34. A method of caring for, removing makeup from and/or for cleansing the skin, lips and/or eyes and/or hair, comprising applying the composition according to claim 17 to said skin, lips, eyes and/or hair.
